(19) United States
(12) Patent Application Publication
(10) Pub. No.: US 2008/0251671 A1
(43) Pub. Date: Oct. 16, 2008

(54) CAR-LADEN BIKE AUXILIARY SUPPORT

(76) Inventor: Hsiang-lan Chiu, Tainan Hsien (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 11/734,132

(22) Filed: Apr. 11, 2007

(51) Int. Cl. B60R 9/10

(52) U.S. Cl. 248/323

(57) ABSTRACT

A car-laden bike auxiliary support includes a locating rod having its both ends respectively fixed with a fastening unit; a fastening belt extending from each fastening unit and provided with a toothed outer surface; a latching portion being disposed to each fastening unit; a one-way ratchet-locking block being disposed on the latching portion to engage with the toothed outer surface of the fastening belt so as to firmly secure the locating rod at where between a head tube and a seat post of a bike onto a car to facilitate transportation of the bike before reaching a destination.

### BACKGROUND OF THE INVENTION

(a) Field of the Invention

The present invention is related to a car laden bike auxiliary support, and more particularly, to a locating rod with its both ends respectively fixed with a fastening unit to secure the locating rod to where between a head tube and a seat post of the bike to facilitate transportation of the bike on a car.

(b) Description of the Prior Art

Many people schedule their outdoor activities to spend their weekends and off-road riding a bike is one of the most preferred activities. A bike has to be first secured to a car before arriving at a destination. Accordingly, a mounting rack is usually provided on the car to secure the bike to a crossbar disposed between a head tube and a seat post of the bike. However, some bikes do not have the crossbar, thus they are prevented from being secured to a car. To correct this problem, a connection rod having both ends respectively disposed with a locating portion is provided to secure the bike to where between the head tube and the seat post. However, a diameter of each of both locating portions is fixed while a diameter of the head tube and that of the seat post may vary depending on the bike. A varnish coating on the head tube and the seat post is vulnerable to be scratched since either locating portion of the connection rod is not necessarily tightly engaged with the head tube and/or the seat post. Furthermore, the bike is subject to greater vibration in transportation to cause parts of the bike to easily get loosened up, resulting in uncertainty in riding the bike.

### SUMMARY OF THE INVENTION

The primary purpose of the present invention is to provide a car-laden auxiliary support for a bike, particularly for one not provided with a crossbar. To achieve the purpose, the auxiliary support is related to a locating rod including a first section and a second section with the former having a greater outer diameter than that of the latter. Two fastening units are respectively fixed to both ends of the locating rod. A fastening belt is disposed on each fastening unit. The fastening belt has a toothed outer surface. A latching portion disposed on each fastening unit is provided with a one-way ratchet locking block.

A locating member penetrates through an outer edge of the first section of the locating rod and a slide is recessed on an outer edge of the second section of the locating rod for the locating member to hold against in the slide.

Both fastening units are respectively fixed to an end of each of the first section and the second section of the locating rod.

A mobile slip-proof pad is provided on an inner side of the fastening belt, and a slip-proof block is disposed on the fastening unit corresponding in position to the slip-proof pad.

The present invention provides the following advantages:

1. The locating rod of the present invention allows it to be firmly positioned at where between a head tube and a seat post of the bike to function as a crossbar of a bike for securing the bike to a car to facilitate transportation.

2. The locating rod of the present invention includes a first section and a second section with each retractable to allow adjustment for a proper spacing depending on that between the head tube and the seat post of the bike.

3. The present invention allows easy and fast operation since it takes only to pull the fastening belt to secure the fastening unit, or to slightly press the ratchet-locking block to release the fastening unit.

4. The present invention is adaptable to head tubes and seat posts in different diameters since its fastening unit is pulled to tighten up in one direction to firmly secure the bike.

### BRIEF DESCRIPTION OF THE DRAWINGS

FIG. 1 is a perspective view of the present invention.

FIG. 2 is a sectional view showing a local assembly of the present invention.

FIG. 3 is a side view of the present invention applied to a bike.

FIG. 4 is a schematic view showing a head tube of the bike is secured by means of a fastening belt of the present invention.

FIG. 5 is another schematic view showing the head tube of the bike is secured by means of the fastening belt of the present invention.

FIG. 6 is a schematic view showing the bike is secured to and laden by a car.

### DETAILED DESCRIPTION OF THE PREFERRED EMBODIMENT

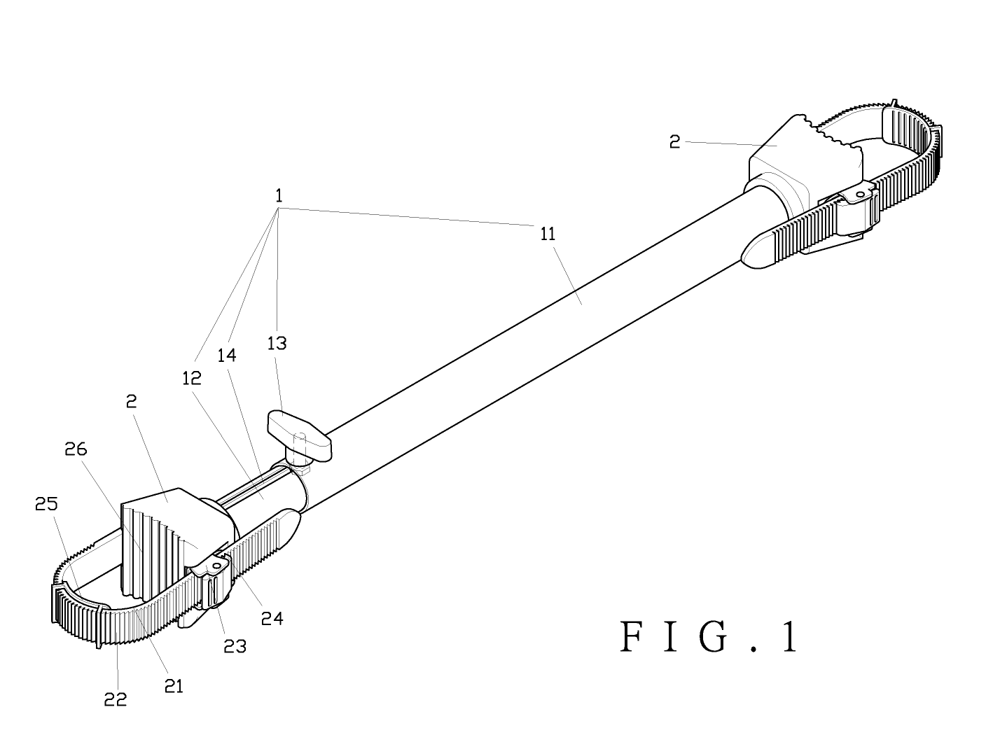

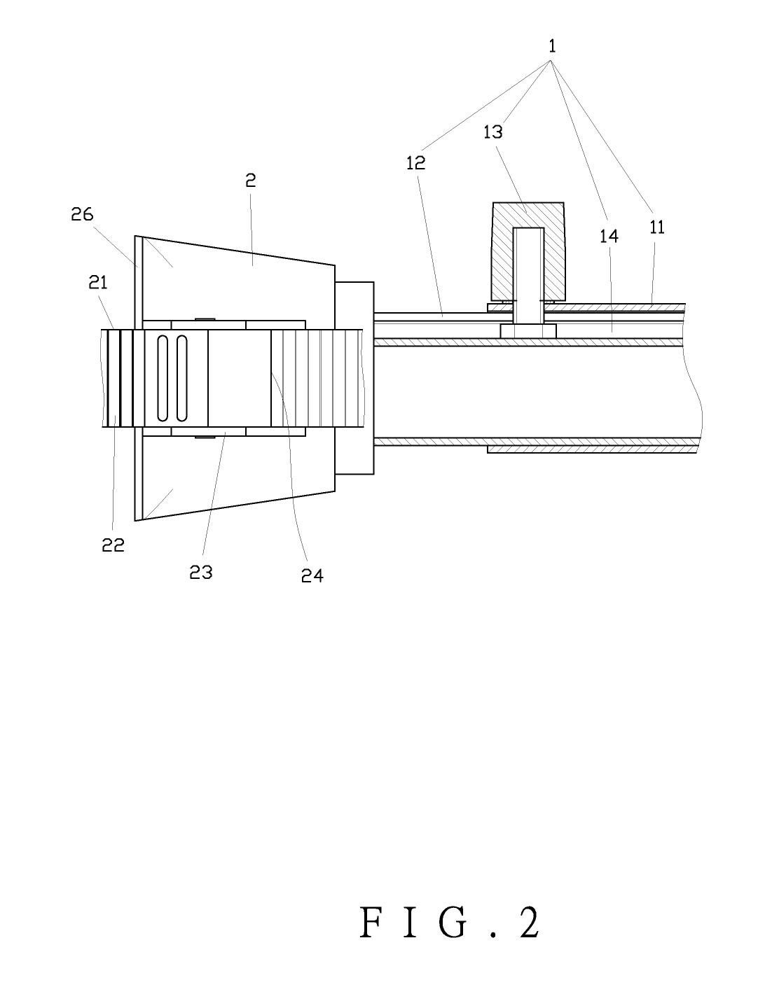

Referring to FIGS. 1 and 2, the present invention comprises a locating rod (1) and two fastening units (2).

The locating rod (1) contains a hollow first section (11) and a hollow second section (12). The outer diameter of the first section (11) is greater than that of the second section (12) to permit the second section (12) to be inserted into and move back and forth in the first section (11). A locating member (13) penetrates through an outer edge of the first section (11), and a slide (14) is recessed on an outer edge of the second section (12) for the locating member (13) to hold against in the slide (14) so as to adjust the range between the first section (11) and the second section (12).

Both fastening units (2) are respectively secured to both ends of the locating rod (1), that is, to one end of the first section (11) and one end of the second section (12). A fastening belt (21) extending from each fastening unit (2) is provided with a toothed outer surface (22). A latching portion (23) is disposed on one side of each fastening unit (2). A one-way ratchet-locking block (24) is disposed on the latching portion (23) to allow the fastening belt (21) to extend into the latching portion (23) while the toothed outer surface (23) of the fastening unit (2) is engaged with the ratchet-locking block (24) so that the fastening belt (21) is pulled to tighten up only in one direction. To release the fastening belt (21), the fastening belt (21) is pulled out by slightly pressing the ratchet-locking block (24). A slip-proof pad (25) is provided on the fastening belt (21), and a slip-proof block (26) is disposed on the fastening unit (2) corresponding in position to the slip-proof pad (25).

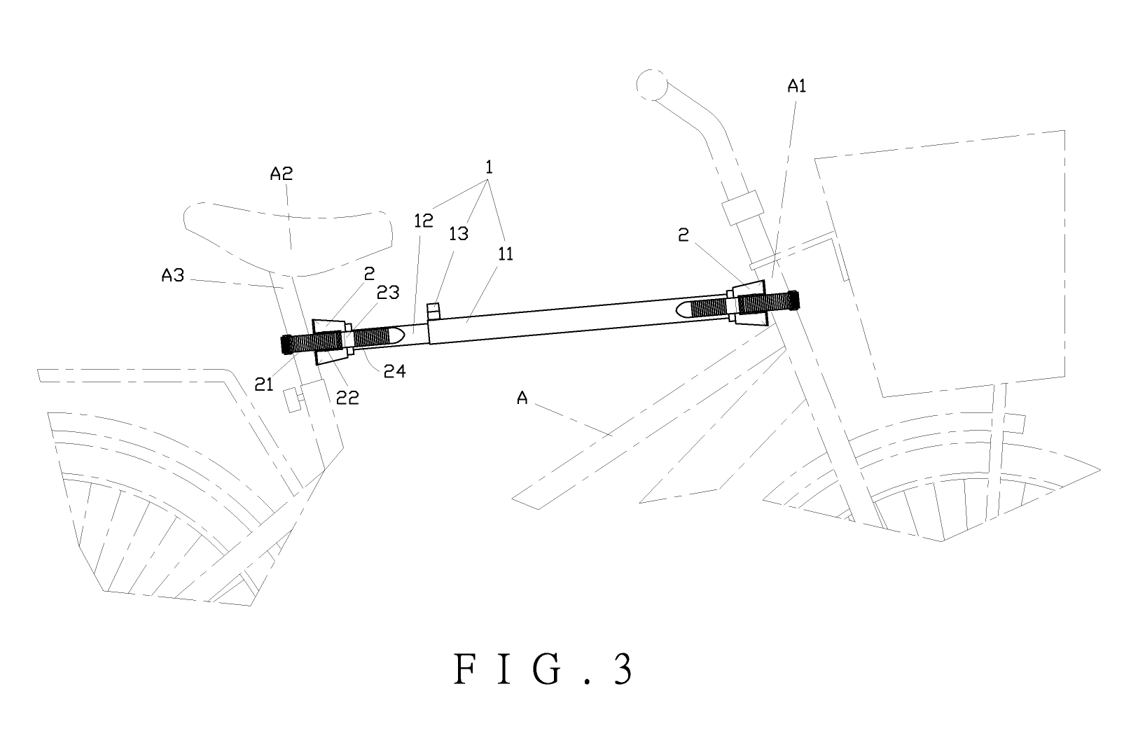

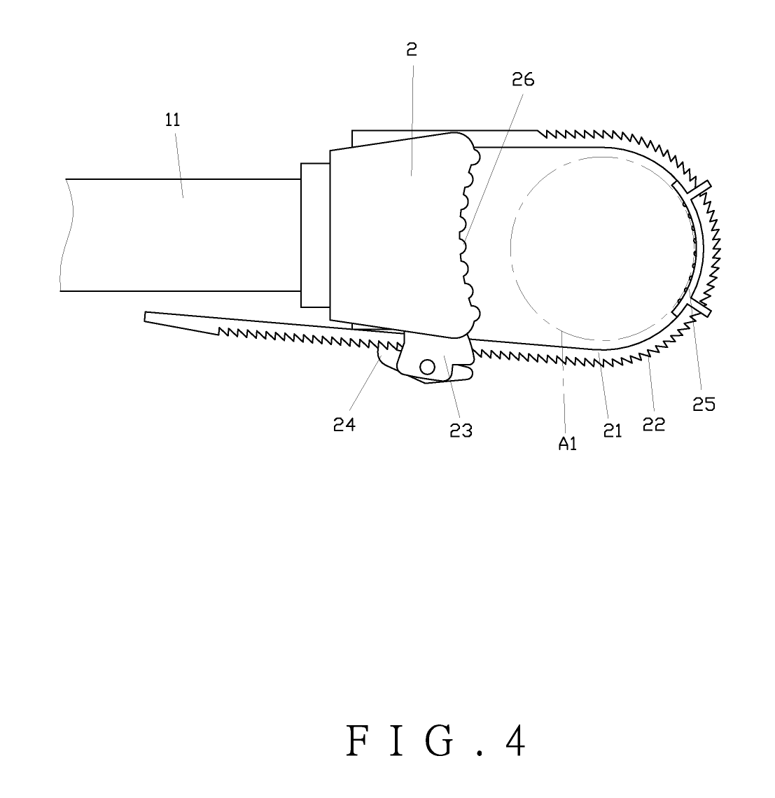

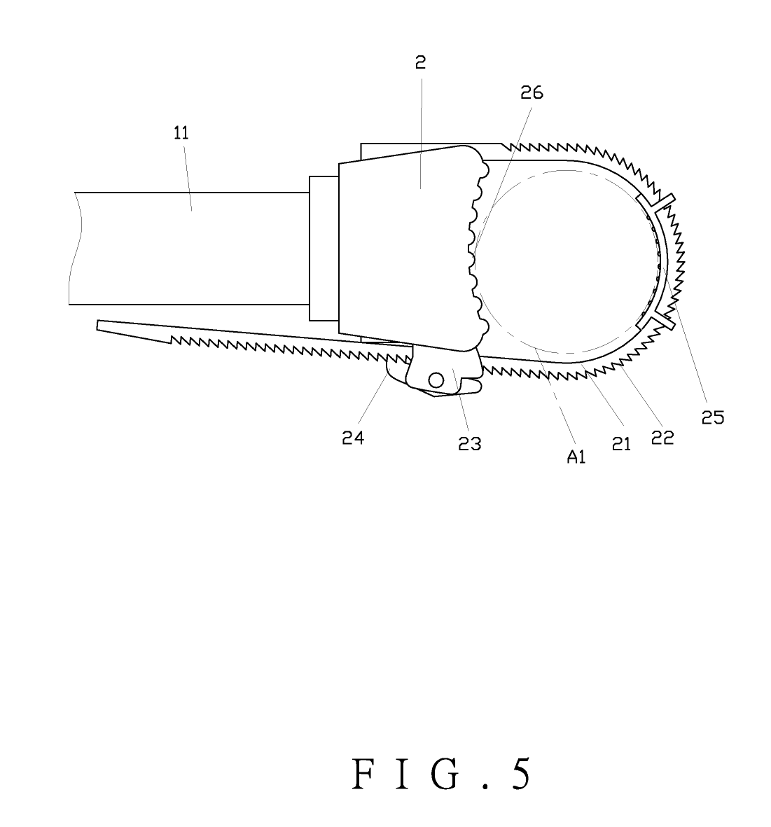

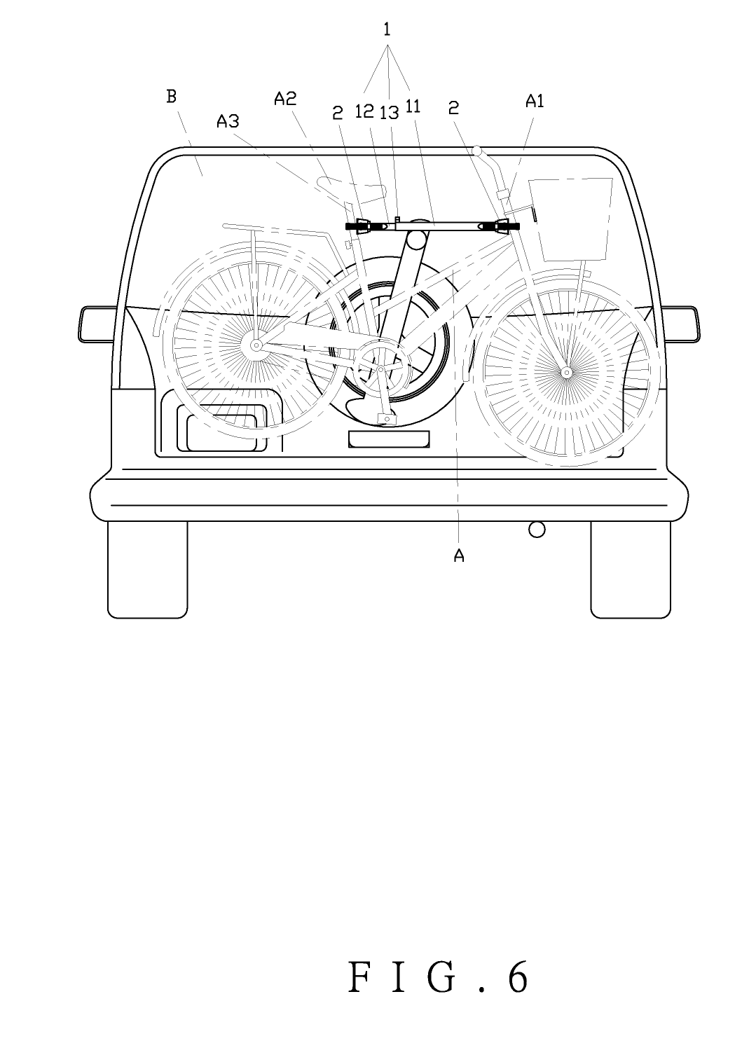

Now referring to FIGS. 3 and 4, the fastening belt (21) of the fastening unit (2) on the first section (11) of the locating rod (1) buckles up a head tube (A1) of a bike (A), and then passes through the latching portion (23) before being pulled for the toothed outer surface (22) of the fastening belt (21) to be one-way latched when engaged by the ratchet-locking block (24) so as to tighten up the fastening belt (21) to the head tube (A1); meanwhile, the head tube (A1) as illustrated in FIG. 5 is clamped by the slip-proof pad (25) and the slip-proof slide (26) of the fastening unit (2) to prevent the fastening unit (2) from sliding or rotating. Similarly, the fastening belt (21) of the fastening unit (2) on the second section (12) buckles up a seat post (A3) below a seat (A2) of the bike (A), passes through the latching portion (23) and is pulled for the toothed outer surface (22) to be one-way engaged and latched by the ratchet-locking block (24) and fastened to the seat post (A3). Both fastening belts (21) allow to be pulled one-way for adjusting to respectively compromise the head tube (A1) and the seat post (A3) in different diameters. Again, the seat post (A3) for being clamped by the slip-proof pad (25) and the slip-proof block (26) of the fastening unit (2) is secured in place without sliding or rotating. Finally, both the first section (11) and the second section (12) are adjusted to such that the locating member (13) on the first section (11) is allowed to extend and move in the slide (14) of the second section (12). Once the adjustment for a proper range is done depending on a length between the head tube (A1) and the seat post (A3) below the seat (A2) of the bike (A), the locating member (13) is turned to hold against the slide (14). The locating rod (1) is firmly secured between the head tube (A1) and the seat post (A3) of the bike (A). As illustrated in FIG. 6, the bike (A) is fixed to a car (B) by means of the locating rod (1) to prevent loosening up or falling off in transition.

To release the fastening unit (2), slightly press the ratchet-locking block (24) to free it from being engaged to the toothed outer surface (22) of the fastening belt (21), and pull the fastening belt (21) out of the fastening unit (2) for it is no longer fastened to the head tube (A1) of the bike (A). Another fastening unit (2) is released in the same manner from the seat post (A3) below the seat (A2) of the bike (A).

What is claimed is:

1. A car-laden bike auxiliary support, comprising:
a locating rod having a first section and a second section, the first section having an outer diameter greater than that of the second section; and
two fastening units fixedly connected to two ends of the locating rod respectively, each of the fastening units comprising a fastening belt, the fastening belt having a toothed outer surface, each of the fastening units further comprising a latching portion, the latching portion comprising a one-way ratchet-locking block.

2. The car-laden bike auxiliary support as claimed in claim 1, wherein the first section is provided with a locating member penetrating through an outer edge of the first section, and a slide is recessed on an outer edge of the second section to hold against the locating member.

3. The car-laden bike auxiliary support as claimed in claim 1, wherein each of the first section and the second section of the locating rod has one end, and the two fastening units are fixedly connected to the ends of the first section and the second section of the locating rod, respectively.

4. The car-laden bike auxiliary support as claimed in claim 1, wherein a mobile slip-proof pad is provided on an inner side of the fastening belt, and each of the fastening units is provided with a slip-proof block corresponding in position to the slip-proof pad.
